(19) United States
(12) Patent Application Publication
(10) Pub. No.: US 2011/0019218 A1
(43) Pub. Date: Jan. 27, 2011

(54) NETWORK DEVICE

(75) Inventor: Tetsuya Kuwahara, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/835,833

(22) Filed: Jul. 14, 2010

(30) Foreign Application Priority Data
Jul. 24, 2009 (JP) 2009-172654

(51) Int. Cl. G06F 1/32; G06F 3/12

(52) U.S. Cl. 358/1.13; 713/323

(57) ABSTRACT

In a network device, a first response unit responds to a check request using state information saved in a storage unit in a case where a save time of the state information does not exceed a first predetermined time when the check request of the operation state of the network device is received in the normal mode, and causes an updating unit to update the state information and responds to the check request using the updated state information in a case where the save time exceeds the first predetermined time. A second response unit responds to the check request using the state information saved in the storage unit when the check request is received in the power saving mode. The updating unit updates the state information when transitioning from the normal mode to the power saving mode.

### CROSS-REFERENCE TO RELATED APPLICATIONS

This application claims priority under 35 U.S.C. §119 to Japanese Patent Application No. 2009-172654, filed on Jul. 24, 2009, which application is hereby incorporated by reference in its entirety.

### BACKGROUND OF THE INVENTION

1. Field of the Invention

The present invention relates to a network device capable of operating in a power saving mode.

2. Description of the Related Art

A digital multifunction peripheral capable of operating in a power saving mode is known. The digital multifunction peripheral transitions to the power saving mode when, for example, an operation is not performed by a user for a specified time. Power consumption is lowered in the power saving mode, since power is not supplied to a main control unit of the digital multifunction peripheral. Thus, a merit in that an operation cost can be alleviated is obtained for the user. Furthermore, a merit of contributing to energy saving measures and environmental measures can be obtained by lowering the power consumption.

A digital multifunction peripheral, a printer, and the like compatible to the Simple Network Management Protocol (SNMP) are known. A user can remotely check the operation states of the digital multifunction peripheral and the printer by operating a Personal Computer (PC).

A technique of holding a response of the printer with respect to an operation check request as a cache file in a network management program installed in the PC or the like is known in relation to the checking of the operation state of the digital multifunction peripheral. When an operation check of the printer is instructed by the user through the PC, the network management program checks the save time of the cache file. If the save time of the cache file is within a specified time, the network management program notifies the operation state of the printer using the cache file. Thus, the load of the printer can be reduced, and communication traffic between the PC and the digital multifunction peripheral can be reduced.

Japanese Laid-Open Patent Publication No. 2000-357145 discloses a network management program compatible to the SNMP. The network management program is installed in the PC or the like, and holds the response of the printer with respect to the operation check request as the cache file. The network management program checks the save time of the cache file when the operation check of the printer is instructed by the user of the PC. If the save time of the cache file is within the specified time, the network management program notifies the operation state of the printer using the cache file. Thus, the load of the printer can be reduced, and the communication traffic between the PC and the digital multifunction peripheral can be reduced.

The network management program transmits an operation check request to the printer if the save time of cache file is longer than the specified time. The printer needs to return to a normal mode when the operation check request is received in the power saving mode. The power consumption of the printer when returning to the normal mode becomes greater than the power consumption at the time of the normal mode due to the warm up of a printer engine, and the like. Therefore, there is a problem in that the power consumption increases when the return to the normal mode is repeated every time the check of the operation state is requested to the digital multifunction peripheral and the printer capable of operating in the power saving mode.

### SUMMARY OF THE INVENTION

In order to overcome the problems described above, preferred embodiments of the present invention provide a network device capable of reducing the number of returns from the power saving mode.

According to a first preferred embodiment of the present invention, a network device includes a main body processing unit and a network controller. The main body processing unit is supplied with power in a normal mode and is not supplied with power in a power saving mode, which has lower power consumption than the normal mode. The network controller, supplied with power in the normal mode and in the power saving mode, controls communication through a network. The network controller includes a storage unit, an updating unit, a first response unit, and a second response unit. The storage unit saves state information created by the main body processing unit, the state information indicating an operation state of the network device. The updating unit updates the state information saved in the storage unit when transitioning from the normal mode to the power saving mode. The first response unit responds to a check request using the state information saved in the storage unit in a case where a save time of the state information does not exceed a first predetermined time when the check request of the operation state of the network device is received in the normal mode, and causes the updating unit to update the state information and responds to the check request using the updated state information in a case where the save time exceeds the first predetermined time. The second response unit responds to the check request using the state information saved in the storage unit when the check request is received in the power saving mode.

To solve the above problems, the network device having the following configuration is provided according to the first preferred embodiment of the present invention. In other words, the network device includes a network controller arranged and programmed to control communication through a network, and a main body processing unit arranged to create state information indicating an operation state of the network device. The main body processing unit is supplied with power in a normal mode and is not supplied with power in a power saving mode, which has lower power consumption than the normal mode. The network controller is supplied with power in the normal mode and in the power saving mode. The network controller includes a storage unit, an updating unit, a first response unit, and a second response unit. The storage unit saves the state information. The updating unit updates the state information saved in the storage unit. The first response unit responds to a check request using the state information saved in the storage unit in a case where a save time of the state information does not exceed a first predetermined time when the check request of the operation state of the network device is received in the normal mode, and causes the updating unit to update the state information and responds to the check request using the updated state information in a case where the save time exceeds the first predetermined time. The second response unit responds to the check request using the state information saved in the storage unit when the check request is received in the power saving mode. The updating unit updates the state information when transitioning from the normal mode to the power saving mode.

According to a second preferred embodiment of the present invention, a network controller includes a power control unit. The power control unit returns the main body processing unit to the normal mode in a case where the save time exceeds a second predetermined time longer than the first predetermined time when the check request is received in the power saving mode. The updating unit updates the state information after returning to the normal mode. The second response unit responds to the check request using the updated state information when the state information is updated.

According to a third preferred embodiment of the present invention, the network device transitions to the power saving mode when the power control unit stops supply of power to the main body processing unit after the updating unit updates the state information.

According to a fourth preferred embodiment of the present invention, the network device transitions from the normal mode to the power saving mode before the second response unit responds to the check request.

According to a fifth preferred embodiment of the present invention, the state information is saved in the storage unit in correspondence with a time stamp indicating a time when the state information is saved in the storage unit. The save time of the state information is calculated based on a saved time set to the time stamp and a current time.

According to a sixth preferred embodiment of the present invention, the time of the time stamp is also updated when the state information is updated by the updating unit.

According to a seventh preferred embodiment of the present invention, the storage unit stores a response table in which the state information and a response content with respect to the check request correspond to each other. The first response unit or the second response unit responds to the check request based on the state information and the response table.

According to an eighth preferred embodiment of the present invention, the main body processing unit further includes a printer unit that is operative to print on a printing medium. The network device continuously receives an operation check packet requesting for a notification of the operation state of the network device, an operation check packet requesting for a notification of an operation state of the printer unit, and an operation check packet requesting for a notification of a warning state or an error state that occurred in the printer unit.

According to a ninth preferred embodiment of the present invention, the network device preferably is a digital multifunction peripheral including a copy function, a facsimile function, a scanner function, and a printer function.

The network device according to a preferred embodiment of the present invention updates the state information saved in the storage unit when transitioning to the power saving mode. The network controller responds to the check request using the state information updated immediately before transitioning to the power saving mode when the check request is received in the power saving mode. The network device thus does not need to return to the normal mode even if the check request is received in the power saving mode, and thus the number of returns from the power saving mode can be reduced. Therefore, the power consumption of the network device can be reduced.

When the check request is received in the normal mode, the network controller responds by using the state information saved in the storage unit if the save time of the state information saved in the storage unit does not exceed a first predetermined time. The network controller thus can rapidly respond to the check request. Furthermore, the number of data input/output of the main body processing unit and the network controller can be reduced since the state information does not need to be acquired from the main body processing unit every time the network controller receives the check request. As the frequency of creating the state information reduces, the load of the main body processing unit can be reduced and minimized. Therefore, the response process of when the check request is received can be simplified, and the power consumption of the network device can be further reduced.

In the network device according to a preferred embodiment of the present invention, the network controller updates the state information saved in the storage unit if the save time of the state information exceeds the first predetermined time. The network controller thus can reliably acquire the state information corresponding to the change of the operation state even if the operation state of the network device changes.

The network device according to a preferred embodiment of the present invention checks whether or not the save time of the state information exceeds the second predetermined time when the check request is received in the power saving mode. The network device returns to the normal mode and updates the state information stored in the storage unit if the save time exceeds the second predetermined time. The response with respect to the check request is made based on the updated state information. The network device thus can make a response corresponding to the change of the operation state even if the operation state of the own device changes in the power saving mode.

The network device according to a preferred embodiment of the present invention again transitions to the power saving mode after returning from the power saving mode to the normal mode and updating the state information stored in the storage unit. The network device thus can further reduce the power consumption as the time of operating in the normal mode becomes shorter.

These and other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a network system including a digital multifunction peripheral 1 according to a preferred embodiment of the present invention.

FIG. 2 is a view illustrating contents of a response table.

FIG. 3 is a flowchart of a process performed by the digital multifunction peripheral when transitioning to a power saving mode.

FIG. 4 is a flowchart of a process performed by the digital multifunction peripheral when receiving an SNMP packet.

FIG. 5 is a flowchart of a process performed by a network controller for executing a response information transmission process.

### DETAILED DESCRIPTION OF PREFERRED EMBODIMENTS

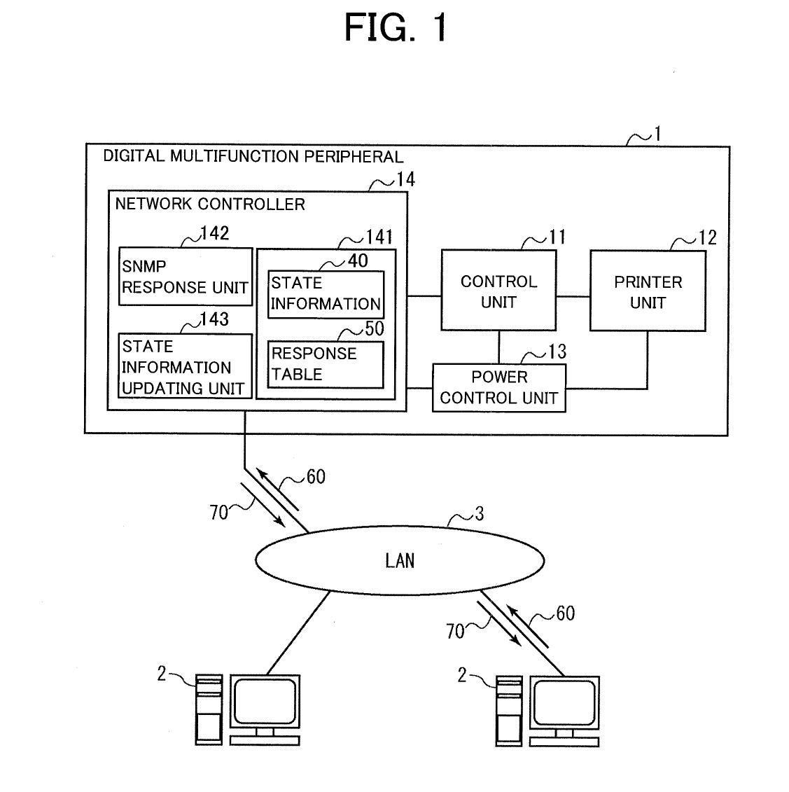

Preferred embodiments of the present invention will be described below with reference to the drawings. FIG. 1 is a block diagram illustrating a network system including a digital multifunction peripheral 1 according to the present preferred embodiment.

The digital multifunction peripheral 1 is connected to a Local Area Network (LAN) 3. The PCs 2, 2 are connected to the LAN 3.

The digital multifunction peripheral 1 preferably is a multi-function device having a copy function, a facsimile function, a scanner function, a printer function, and the like. The user can use the printer function of the digital multifunction peripheral 1 by sending a print instruction from the PC 2 to the digital multifunction peripheral 1 through the LAN 3. The user can also use the copy function, the facsimile function, and the like of the digital multifunction peripheral 1 by operating an operation panel (not illustrated) of the digital multifunction peripheral 1.

The configuration of the digital multifunction peripheral 1 will be described first. The digital multifunction peripheral 1 includes a control unit 11, a printer unit 12, a power control unit 13, and a network controller 14. In FIG. 1, a processing unit related to the scanner function, the facsimile function, and the like of the digital multifunction peripheral 1 is not illustrated.

The control unit 11 includes a Central Processing Unit (CPU), a Random Access Memory (RAM), and the like, and performs overall control of the digital multifunction peripheral 1.

The printer unit 12 prints print data transmitted from the PC 2 on a printing medium such as recording paper. Alternatively, the printer unit 12 prints facsimile data or the like received by the facsimile unit (not illustrated) on the printing medium.

The power control unit 13 controls the supply power to each element of the digital multifunction peripheral 1 according to a normal mode and a power saving mode. The normal mode and the power saving mode will be described later.

The network controller 14 is connected to the LAN 3, and controls communication through the LAN 3. The network controller 14 controls the communication based on, for example, Transmission Control Protocol/Internet Protocol (TCP/IP).

The network controller 14 includes a storage unit 141, an SNMP response unit 142, and a state information updating unit 143.

The storage unit 141 stores state information 40 and a response table 50. The state information 40 is information indicating the operation state of the digital multifunction peripheral 1, the operation state of the printer unit 12, and the like. The storage unit 141 saves the state information 40 in correspondence with a time stamp indicating a time at which the state information 40 is saved. The response table 50 is a table in which the operation state of the digital multifunction peripheral 1 and the response content with respect to an SNMP packet (hereinafter referred to as “operation check packet”) 60 requesting for the operation check correspond to each other.

The SNMP response unit 142 responds to the SNMP packet received from the PC 2. The SNMP response unit 142, for example, executes a response process with respect to the operation check packet 60 based on the state information 40 and the response table 50 saved in the storage unit 141.

The state information updating unit 143 acquires the state information 40 created by the control unit 11, and updates the state information 40 saved in the storage unit 141. A timing at which the state information updating unit 143 updates the state information 40 will be described later.

The digital multifunction peripheral 1 operates in either the normal mode or the power saving mode having different power consumption according to the usage state of the user.

The normal mode is a mode of supplying power to the entire digital multifunction peripheral 1. The digital multifunction peripheral 1 is divided into a main body processing unit and the network controller 14 as a configuring unit to supply power. The main body processing unit includes the control unit 11, the printer unit 12, the operation panel (not illustrated), and the like. In the normal mode, the power control unit 13 supplies power to the main body processing unit and the network controller 14.

In the power saving mode, the power is supplied only to the network controller 14 of the main body processing unit and the network controller. The power is not supplied to the main body processing unit.

For example, the digital multifunction peripheral 1 transitions from the normal mode to the power saving mode if a standby state is continued for a certain period of time. The digital multifunction peripheral 1 returns to the normal mode when the user pushes the cancel button of the power saving mode, and the like. The standby state refers to a state where the process to be executed does not exist and the operation from the operation panel and the remote operation from the PC 2 are being waited.

The network controller 14 can respond to the SNMP packet transmitted by the PC 2 since the power is also supplied in the power saving mode. The digital multifunction peripheral 1 can reduce the number of returns from the power saving mode as the network controller 14 operates as an SNMP agent irrespective of the power saving mode or the normal mode.

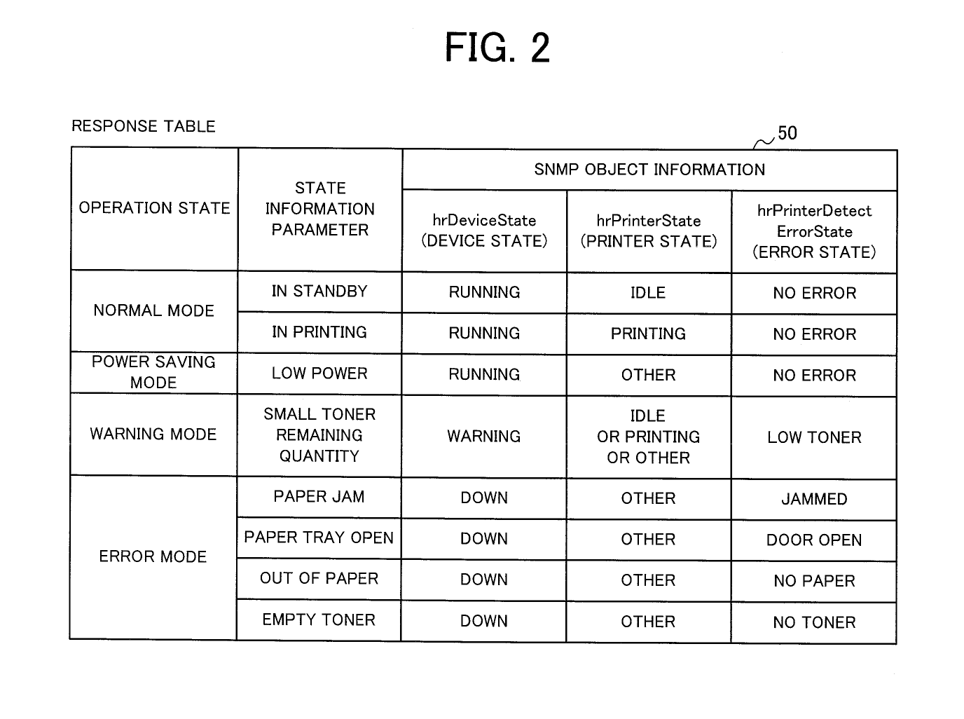

FIG. 2 is a view illustrating contents of the response table 50. The operation states of the digital multifunction peripheral 1 and the printer unit 12 are set in the first row of the response table 50. The normal mode and the power saving mode show the operation state of the digital multifunction peripheral 1, as described above. A warning mode and an error mode show the operation state of the printer unit 12.

The warning mode indicates that the printer unit 12 can be operated but the timing at which the maintenance task of the printer unit 12 is required is soon. The error mode indicates that the printer unit 12 cannot be operated due to occurrence of physical drawbacks and the like in the printer unit 12.

The warning mode or the error mode may simultaneously exist with the normal mode and the power saving mode. For example, the normal mode and the error mode simultaneously exist when a paper jam occurs in the printer unit 12 while the digital multifunction peripheral 1 is in the normal mode. If the standby time of the digital multifunction peripheral 1 elapses for a specified time without the paper jam being resolved, the digital multifunction peripheral 1 transitions to the power saving mode with the error mode continued. As a result, the power saving mode and the error mode simultaneously exist.

The second row indicates the parameter set in the state information 40. Here, “in standby” and “in printing” correspond to the normal mode. “Low power” corresponds to the power saving mode. “Small toner remaining quantity” corresponds to the warning mode. “Paper jam”, “paper tray open”, “out of paper”, and “empty toner” correspond to the error mode.

The third row indicates a Management Information Base (MIB) transmitted as a response with respect to the operation check packet 60, and is set for every object defined in the SNMP. Here, “hrDeviceState (device state)” is an object requesting for a notification of the operation state of the digital multifunction peripheral 1. Furthermore, “hrPrinterState (printer state)” is an object requesting for a notification of the printer unit 12. Moreover, “hrPrinterDetectErrorState (error state)” is an object requesting for a notification of the warning state or the error state that occurred in the printer unit 12.

When receiving the operation check packet 60, the SNMP response unit 142 sets the MIB corresponding to the parameter set in the state information 40 in response information 70 and transmits the same. For example, consider a case in which the digital multifunction peripheral 1 receives the operation packet 60 including three objects of the device state, the printer state, and the error state. In this case, if “in printing” is set in the state information 40, the SNMP response unit 142 transmits the response information 70 set with “running”, “printing”, and “no Error” corresponding to each object to the transmission source of the operation check packet 60.

If “paper jam” is set in the state information 40 when the operation check packet 60 including only the device state for the object is received, the SNMP response unit 142 transmits the response information 60 set with “down”.

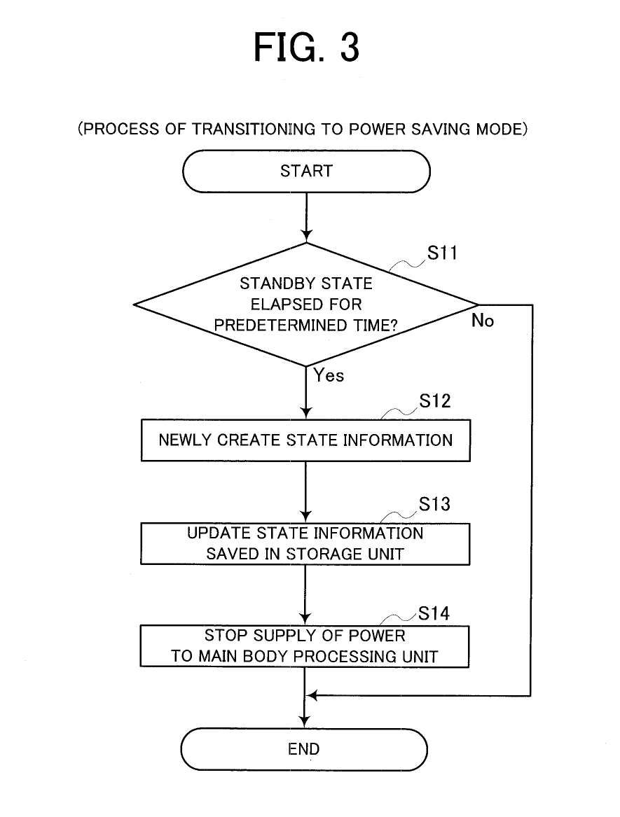

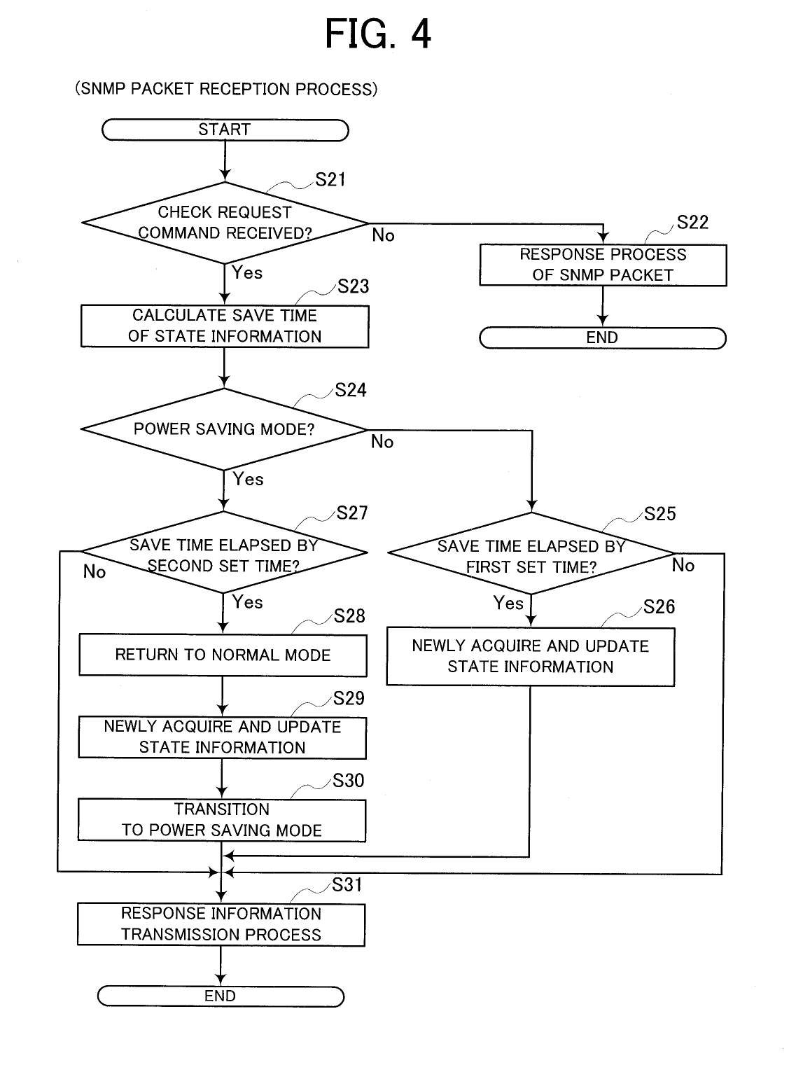

The operation of the digital multifunction peripheral 1 will be described with reference to FIGS. 3 and 4.

FIG. 3 is a flowchart illustrating the operation of the digital multifunction peripheral 1 when the digital multifunction peripheral 1 transitions from the normal mode to the power saving mode.

The power control unit 13 determines the transition to the power saving mode when the standby state in the normal mode elapsed for a specified time (Yes in step S11). The control unit 11 newly creates the state information 40 corresponding to the operation state of the digital multifunction peripheral 1 (step S12).

The state information updating unit 143 overwrites the state information 40 saved in the storage unit 141 with the state information 40 newly created by the control unit 11, and saves the same (step S13). The time stamp of the state information 40 is also updated to the time of overwrite and save. The digital multifunction peripheral 1 transitions to the power saving mode when the power control unit 13 stops the power supply to the main body processing unit (step S14). The network controller 14 then can notify the operation states of the digital multifunction peripheral 1 and the printer unit 12 based on the state information immediately before transitioning to the power saving mode even when the operation check packet 60 is received in the power saving mode.

FIG. 4 is a flowchart illustrating a flow of processes when the digital multifunction peripheral 1 receives the SNMP packet. The processes illustrated in FIG. 4 start when the network controller receives the SNMP packet regardless of whether the digital multifunction peripheral 1 is in the normal mode or the power saving mode.

When receiving the SNMP packet that is not the operation check packet 60 (No in step S21), the SNMP response unit 142 performs the response process corresponding to the received SNMP packet (step S22). For example, the process of step S22 is performed when the received SNMP packet is the packet requesting the specification information of the digital multifunction peripheral 1, and the like.

When receiving the operation check packet 60 (Yes in step S21), the save time of the state information 40 saved in the storage unit 141 is calculated (step S23). The save time of the state information 40 is calculated based on the save time set to the time stamp of the state information 40 and the current time. That is, the save time of the state information 40 indicates the time from the last update time of the state information 40 saved in the storage unit 141 to the current time. The state information updating unit 143 checks whether or not the digital multifunction peripheral 1 is in the power saving mode (step 24).

If the digital multifunction peripheral 1 is in the normal mode (No in step S24), the state information updating unit 143 checks whether or not the save time is longer than a first set time (step S25). The first set time is set to a time (e.g., one second) assumed that the operation states of the digital multifunction peripheral 1 and the printer unit 12 do not change.

For example, assume a case in which “13 hr 45 min. 52.045 sec.” is recorded in the time stamp of the state information 40 and the current time is “13 hr 45 min. 53.368 sec.”. In this case, the state information updating unit 143 instructs the control unit 11 to create the state information 40 since the save time of the state information 40 is longer than the first set time (Yes in step S25). The state information updating unit 143 acquires the newly created state information 40, and updates the state information 40 saved in the storage unit 141 (step S26). In this case, the time stamp of the state information 40 is also updated. The SNMP response unit 142 executes the response process with respect to the operation check packet 60 using the updated state information 40 (step S31).

If the save time of the state information 40 is shorter than the first set time (No in step S25), the SNMP response unit 142 executes the response information transmission process using the state information 40 being saved in the storage unit 141 (step S31).

The network controller 14 sometimes continuously receives the operation check packet 60 in which the device state is specified for the object, the operation check packet 60 in which the printer state is specified, and the operation check packet 60 in which the error state is specified. In such a case as well, the network controller 14 does not need to acquire the state information 40 from the control unit 11 every time the operation check packet 60 is received. Therefore, the number of data input/output between the control unit 11 and the network controller 14 can be reduced, and the power consumption of the digital multifunction peripheral 1 in the normal mode can be reduced.

The description will now return to step S24. If the digital multifunction peripheral 1 is in the power saving mode (Yes in step S24), the state information updating unit 143 checks whether or not the save time of the state information 40 exceeds a second set time (step S27). That is, the digital multifunction peripheral 1 checks whether or not the second set time has elapsed after transitioning to the power saving mode.

The second set time is set to a time (e.g., 30 minutes) longer than the first set time. This is because the operation states of the digital multifunction peripheral 1 and the printer unit 12 are less likely to change in the power saving mode.

If the save time of the state information 40 exceeds the second set time (Yes in step S27), the state information updating unit 143 instructs the power control unit 13 to cancel the power saving mode. The digital multifunction peripheral 1 then returns to the normal mode (step S28). The state information updating unit 143 then acquires the state information 40 newly created by the control unit 11, and updates the state information 40 saved in the storage unit 141 (step S29). The time stamp of the state information 40 is also updated according to the update of the state information 40. The power control unit 13 then transitions the digital multifunction peripheral 1 from the normal mode to the power saving mode (step S30). The SNMP response unit 142 then executes the response process with respect to the operation check packet 60 based on the updated state information 40 (step S31).

If the save time of the state information 40 does not exceed the second set time (No in step S27), the SNMP response unit 142 executes the response process with respect to the operation check packet 60 using the response information 40 saved in the storage unit 141 (step S31).

Therefore, the network controller 14 checks whether or not the save time of the state information 40 is longer than the second set time when the operation check packet 60 is received in the power saving mode. If the save time of the state information 40 is longer than the second set time, the state information 40 saved in the storage unit 141 is updated. Thus, the user of the PC 2 can accurately grasp the operation states of the digital multifunction peripheral 1 and the printer unit 12 even if error or the like occurs in the printer unit 12 when the user pulls out the paper tray in the power saving mode.

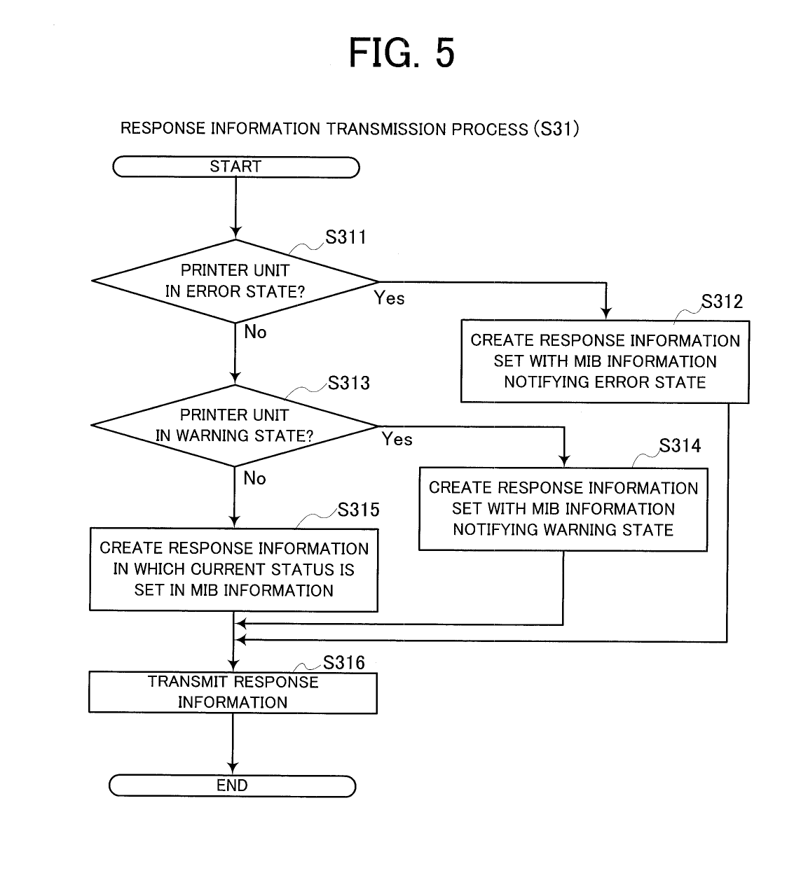

FIG. 5 is a flowchart of a process performed by the network controller 14 for executing the response information transmission process (step S31).

First, the SNMP response unit 142 checks the operation state of the printer unit 12 with reference to the state information 40 saved in the storage unit 141 (step S311). If the printer unit 12 is in the error state (Yes in step S311), the SNMP response unit 142 creates the response information 70 set with the MIB indicating the error content of the printer unit 12 based on the response table 50 (step S312).

If the printer unit 12 is in the warning state (No in step S311, Yes in step S313), the SNMP response unit 142 creates the response information 70 set with the MIB indicating the warning content (step S314).

If the printer unit 12 is not in the error state nor in the warning state (No in step 5311, No in step S313), the SNMP response unit 142 creates the response information 70 set with the MIB indicating the current operation state of the digital multifunction peripheral 1 (step S315).

The SNMP response unit 142 then transmits the created response information 70 to the transmission source of the operation check packet 60 (step S316), and terminates the response information transmission process (step S31).

As described above, the digital multifunction peripheral 1 according to the present preferred embodiment responds using the state information 40 saved in the storage unit 141 if the save time of the state information 40 is within the first set time when the operation check packet 60 is received in the normal mode. Thus, the frequency of the input/output process between the control unit 11 and the network controller 14 lowers, and the power consumption of the digital multifunction peripheral 1 in the normal mode can be reduced.

The digital multifunction peripheral 1 also responds using the state information 40 saved in the storage unit 141 if the save time of the state information 40 is within the second set time when the operation check packet 60 is received in the power saving mode. Thus, the device does not need to return to the normal mode every time the operation check packet 60 is received, and hence the power consumption of the digital multifunction peripheral 1 can be efficiently reduced.

An example in which the network controller 14 saves the state information 40 and the response table 50 in the storage unit 141 has been described in the present preferred embodiment, however, the present invention is not limited thereto. For example, the network controller 14 may save the MIB in the storage unit 141.

Furthermore, an example in which the digital multifunction peripheral 1 is operable in the normal mode and the power saving mode has been described in the present preferred embodiment, however, other power modes may also be employed. For example, the digital multifunction peripheral 1 may have a print mode in which the power is not supplied to the main body processing unit excluding the printer unit 12 and the power is supplied to the printer unit 12 and the network controller 14. The network controller 14 operates similar to the power saving mode even in the print mode.

In the process illustrated in FIG. 4, an example in which the state information updating unit 143 updates the state information 40 saved in the storage unit 141 (step S29) and then again transitions to the power saving mode (step S30) has been described, however, the present invention is not limited thereto. That is, the digital multifunction peripheral 1 may continue the normal mode after the process of step S29.

An example in which the main body processing unit includes the control unit 11, the printer unit 12, and the operation panel (not illustrated) has been described in the present preferred embodiment, however, the present invention is not limited thereto. The main body processing unit merely needs to include at least the control unit 11. That is, in the normal mode, the power merely needs to be supplied to the control unit 11 and the network controller 14.

While the present invention has been described with respect to preferred embodiments thereof, it will be apparent to those skilled in the art that the disclosed invention may be modified in numerous ways and may assume many preferred embodiments other than those specifically set out and described above. Accordingly, it is intended by the appended claims to cover all modifications of the present invention that fall within the true spirit and scope of the present invention.

What is claimed is:

1. A network device comprising:
a main body processing unit supplied with power in a normal mode and not supplied with power in a power saving mode, which has lower power consumption than the normal mode; and
a network controller, supplied with power in the normal mode and in the power saving mode, to control communication through a network; wherein
the network controller includes:
a storage unit arranged to save state information created by the main body processing unit, the state information indicating an operation state of the network device;
an updating unit arranged to update the state information saved in the storage unit when transitioning from the normal mode to the power saving mode;
a first response unit arranged to respond to a check request using the state information saved in the storage unit in a case where a save time of the state information does not exceed a first predetermined time when the check request of the operation state of the network device is received in the normal mode, and to cause the updating unit to update the state information and respond to the check request using the updated state information in a case where the save time exceeds the first predetermined time; and
a second response unit arranged to respond to the check request using the state information saved in the storage unit when the check request is received in the power saving mode.

2. The network device according to claim 1, wherein
the network controller includes a power control unit arranged to return the main body processing unit to the normal mode in a case where the save time exceeds a second predetermined time longer than the first predetermined time when the check request is received in the power saving mode;
the updating unit updates the state information after returning to the normal mode; and
the second response unit responds to the check request using the updated state information when the state information is updated.

3. The network device according to claim 2, wherein the network device transitions to the power saving mode when the power control unit stops supply of power to the main body processing unit after the updating unit updates the state information.

4. The network device according to claim 3, wherein the network device transitions from the normal mode to the power saving mode before the second response unit responds to the check request.

5. The network device according to claim 1, wherein
the state information is saved in the storage unit in correspondence with a time stamp indicating a time when the state information is saved in the storage unit; and
the save time of the state information is calculated based on a saved time set to the time stamp and a current time.

6. The network device according to claim 5, wherein a time of the time stamp is also updated when the state information is updated by the updating unit.

7. The network device according to claim 1, wherein
the storage unit stores a response table in which the state information and a response content with respect to the check request correspond to each other; and
the first response unit or the second response unit responds to the check request based on the state information and the response table.

8. The network device according to claim 1, wherein
the main body processing unit further includes a printer unit arranged to print on a printing medium; and
the network device continuously receives an operation check packet requesting for a notification of the operation state of the network device, an operation check packet requesting for a notification of an operation state of the printer unit, and an operation check packet requesting for a notification of a warning state or an error state that occurred in the printer unit.

9. The network device according to claim 1, wherein the network device is a digital multifunction peripheral including a copy function, a facsimile function, a scanner function, and a printer function.
